(19) United States
(12) Patent Application Publication
(10) Pub. No.: US 2025/0130084 A1
(43) Pub. Date: Apr. 24, 2025

(54) FLUID FLOW METERS

(71) Applicant: Hewlett-Packard Development Company, L.P., Spring, TX (US)

(72) Inventors: Daryl Eugene ANDERSON, Corvallis, OR (US); Eric T. MARTIN, Corvallis, OR (US)

(73) Assignee: Hewlett-Packard Development Company, L.P., Spring, TX (US)

(21) Appl. No.: 18/691,815

(22) PCT Filed: Sep. 14, 2021
(86) PCT No.: PCT/US2021/071438

§ 371 Date: Mar. 13, 2024

(51) Int. Cl. G01F 1/696; G05D 7/06

(52) U.S. Cl. CPC G01F 1/696; G05D 7/0688

(57) ABSTRACT

In some examples, a fluid flow meter for a conduit to carry a fluid, includes a first voltage connection point, a second voltage connection point, and a heater. The fluid flow meter includes a plurality of resistive sensors comprising a first resistive sensor on a first side of the heater and a second resistive sensor on a second side of the heater, wherein the first resistive sensor and the second resistive sensor are connected in series between the first voltage connection point and the second voltage connection point, wherein a sense connection point between the first resistive sensor and the second resistive sensor is to output a sense voltage that provides an indication of a fluid flow in the conduit.

### BACKGROUND

A fluid dispensing system can dispense fluid towards a target or manipulate fluid flow or displacement. In some examples, a fluid dispensing system can include a printing system, such as a two-dimensional (2D) printing system or a three-dimensional (3D) printing system. A printing system can include printhead devices that include fluidic actuators to cause dispensing of printing liquids. A fluid dispensing system or another type of fluidic system can also be used in a non-printing context.

### BRIEF DESCRIPTION OF THE DRAWINGS

Some implementations of the present disclosure are described with respect to the following figures.

FIG. 1 is a block diagram of a fluidic device, according to some examples.

FIGS. 2-4 are schematic diagrams of differential fluid flow meters according to various examples.

FIG. 5 is a block diagram of a system according to some examples.

FIG. 6 is a block diagram of the fluid flow meter according to some examples.

FIG. 7 is a block diagram of a fluidic die according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A fluidic device includes fluid conduits through which a fluid can flow under various conditions. As used here, a “fluid” can refer to a liquid or a gas. The fluidic device can include fluidic actuators that when activated cause dispensing (e.g., ejection or other flow) of a fluid. For example, the dispensing of the fluid can include ejection of fluid droplets by activated fluidic actuators from respective nozzles of the fluidic device. In other examples, an activated fluidic actuator (such as a pump) can cause fluid to flow through a fluid conduit or fluid chamber (non-ejection fluid flow). Activating a fluidic actuator to dispense fluid can thus refer to activating the fluidic actuator to eject fluid from a nozzle or activating the fluidic actuator to cause a flow of fluid through a flow structure, such as a fluid conduit, a fluid chamber, and so forth. In other examples, a fluidic die may manipulate fluid flow or displacement in other ways.

The foregoing are examples of micro-level fluid flow driven by fluidic actuators. In other examples, fluid flow in the fluidic device can include a macro-level fluid flow caused by a system in which the fluidic device is installed. For example, the system can include a pump or a backpressure regulator that produces a fluid differential in the fluidic device to cause fluid flow.

In some examples, fluidic actuators in a fluidic device include thermal-based fluidic actuators including heating elements, such as resistive heaters. When a heating element is activated, the heating element produces heat that can cause vaporization of a fluid to cause nucleation of a vapor bubble (e.g., a steam bubble) proximate the thermal-based fluidic actuator that in turn causes dispensing of a quantity of fluid, such as ejection from an orifice of a nozzle or flow through a fluid conduit or fluid chamber. In other examples, a fluidic actuator may be a displacement-type actuator, which can include, in some examples, a piezoelectric membrane that when actuated applies a mechanical force to dispense a quantity of fluid.

In examples where a fluidic device includes nozzles, each nozzle includes a fluid chamber, also referred to as a firing chamber. In addition, a nozzle can include an orifice through which fluid is dispensed, a fluidic actuator, and possibly a sensor. Each fluid chamber provides the fluid to be dispensed by the respective nozzle. In other examples, a fluidic device can include a microfluidic pump that has a fluid chamber.

Generally, a fluidic actuator can be an ejecting-type fluidic actuator to cause ejection of a fluid, such as through an orifice of a nozzle, or a non-ejecting-type fluidic actuator to cause displacement of a fluid.

In some examples, a fluidic device can include a fluidic die. A “die” refers to an assembly where various layers are formed onto a substrate to fabricate circuitry, fluid chambers, and fluid conduits. Multiple fluidic dies can be mounted or attached to a support structure, such as a print cartridge, a carriage, and so forth.

A fluidic device can be used in a printing system or a fluidic system that is used in a non-printing context. Examples of printing systems include 2D printing systems or 3D printing systems. A non-printing fluidic system can include any of the following: a fluid sensing system, a medical system, a vehicle, a fluid flow control system, and so forth.

In some cases, flow meters are not provided to detect fluid flow in fluid conduits of fluidic devices. Reasons for not including flow meters in fluidic devices may include any or some combination of the following: a flow meter can include complex circuitry that adds to cost or may cause an increase in size of a fluidic device. In other examples, flow meters in fluidic devices can rely on absolute values of measurements made by sensors. Fluid flow detection based on absolute values of measurements can suffer from reliability issues due to noise or variations in characteristics of sensors, variations in power supply and reference voltage levels, variations in environmental conditions such as temperature, and so forth.

In accordance with some implementations of the present disclosure, a differential fluid flow meter can be implemented using relatively simple circuitry that is space efficient and cost effective. The differential fluid flow meter can include a heater and multiple resistive sensors including a first resistive sensor placed on a first side of the heater and a second resistive sensor placed on a second side of the heater. In some examples of the present disclosure, the first resistive sensor and the second resistive sensor are connected in series between a first voltage connection point and a second voltage connection point, such that a sense connection point between the first resistive sensor and the second resistive sensor outputs a voltage that provides an indication of the fluid flow in the flow conduit.

The differential fluid flow meter relies on a differential resistance between the first and second resistive sensors. The voltage at the sense connection point between the series-connected first and second resistive sensors shifts above or below an ambient voltage level based on presence and/or direction of a fluid flow in a conduit and application of heat to a fluid in the conduit. The “midpoint” voltage level refers to a voltage level of the sense connection point in the absence of a fluid flow in the conduit.

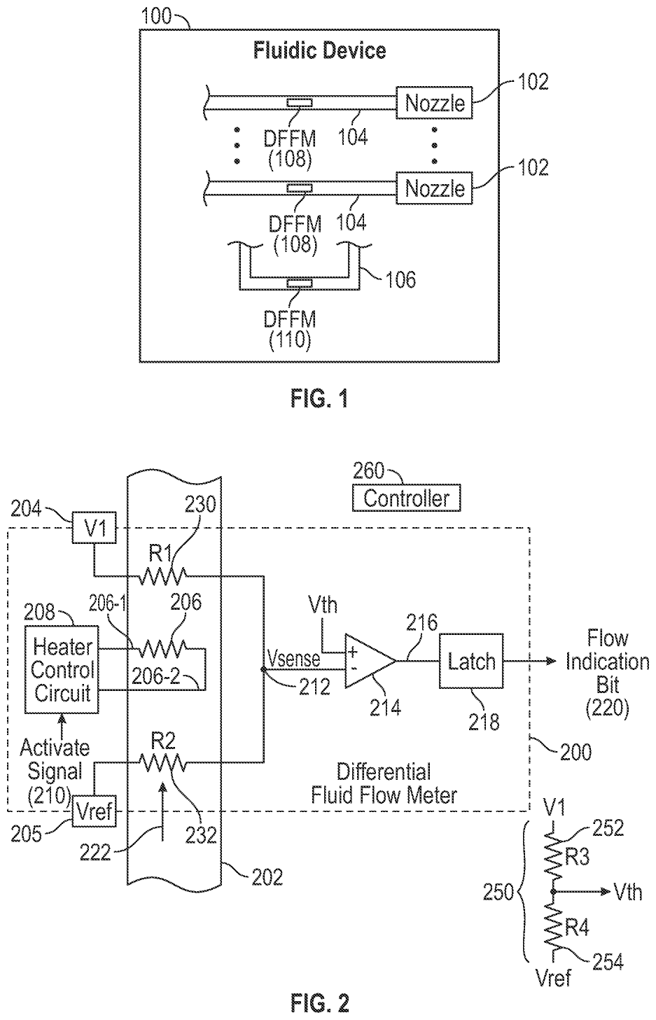

FIG. 1 is a block diagram of a fluidic device 100 according to some examples. The fluidic device in some cases can include a fluidic die, such as a printhead die used in printing systems. In other examples, the fluidic die can be used in a different context.

More generally, the fluidic device 100 can refer to any component that includes a fluid conduit (or multiple fluid conduits).

In the ensuing discussion, reference is made to fluidic devices used in printing examples. However, techniques or mechanisms according to some implementations of the present disclosure can be applied to non-printing contexts as well.

The fluidic device 100 may include nozzles 102. Each nozzle 102 is able to eject a fluid from within the fluidic device 100 to outside the fluidic device 100. For example, if the fluidic device 100 is used in a printing system, the nozzles 102 can be used to eject printing fluid(s) to a target medium.

A nozzle can include a fluid orifice through which fluid can be ejected from a fluid chamber in the fluidic device 100 to outside the fluidic device 100. The nozzle 102 can also include a fluidic actuator that can be activated to cause an ejection of a quantity of fluid through an orifice of the nozzle 102.

Each nozzle 102 is fluidically connected to a corresponding fluid conduit 104. For example, each fluid conduit 104 can carry a fluid to the respective nozzle 102, where the fluid carried to the nozzle 102 can be ejected from the nozzle 102 in response to activation of the respective fluidic actuator. In further examples, each fluid conduit 104 may carry a fluid to multiple nozzles 102, or a nozzle 102 may receive a fluid from multiple fluid conduits 104.

The fluidic device 100 further includes another fluid conduit 106 that is not associated with nozzles. For example, the fluid conduit 106 can be used to circulate a fluid or to carry the fluid to different parts of the fluidic device 100. A fluidic actuator can also be included in the fluid conduit 106 that when activated causes the fluid flow. Alternatively or additionally, a fluid flow in the fluid conduit 106 can be caused by a differential pressure created by an external source, such as in a system that the fluidic device 100 is located in. In further examples, there may be multiple fluid conduits 106 in the fluidic device 100.

Each of the fluid conduits 104 includes a respective differential fluid flow meter 108 (abbreviated as DFFM in FIG. 1). The fluid conduit 106 also includes a differential fluid flow meter 110. Each differential fluid flow meter 108 or 110 is able to detect a fluid flow through the respective fluid conduit 104 or 106.

A differential fluid flow meter refers to a fluid flow meter that includes a differential arrangement of resistive sensors coupled between different voltages, where a sense connection point between the resistive sensors is used for detecting whether or not a fluid flow is present in a fluid conduit.

FIG. 2 shows an example of a differential fluid flow meter 200, which can be an example of the differential fluid flow meter 108 or 110 in FIG. 1. The differential fluid flow meter 200 is to detect a fluid flow in a fluid conduit 202, such as the fluid conduit 104 or 106 in FIG. 1.

The differential fluid flow meter 200 includes a first voltage connection point 204 and a second voltage connection point 205. As used here, a “voltage connection point” can refer any electrically conductive structure, such as a contact pad, an electrical trace, a via, a wire, and so forth, that can be used to electrically connect to a corresponding voltage, such as a voltage that is available in the fluidic device 100 when the fluidic device 100 is connected to an electrical power source.

In some examples, the first voltage connection point 204 is electrically connected to a power supply voltage V1, such as 3.3 volts, 5 volts, and so forth. The second voltage connection point 205 is electrically connected to a reference voltage (Vref), such as ground or a different reference voltage. A ground voltage is at zero volts. Alternatively, a reference voltage is a positive or negative voltage that is less than the power supply voltage V1.

Resistive sensors 230 and 232 having respective resistances R1 and R2 are connected in series between the first and second voltage connection points 204 and 205 (e.g., connected in series between V1 and Vref). Although FIG. 2 shows just two resistive sensors 230 and 232, in other examples, the differential fluid flow meter 200 can include more than two resistive sensors.

The resistive sensors 230 and 232 are placed along the fluid conduit 202 such that the resistive sensors 230 and 232 are fluidically exposed to any fluid that is present in the fluid conduit 202. For example, the resistive sensors 230 and 232 may be mounted to a wall or built into a floor of the fluid conduit 202.

In some examples, the resistive sensors 230 and 232 are implemented using resistors, which can be formed using an electrically resistive material such as polysilicon or another type of resistive material. For example, an electrically resistive material can be deposited onto a substrate or other layer of a fluidic die to form a resistor.

The differential fluid flow meter 200 further includes a heater 206 that is placed in the fluid conduit 202 between the resistive sensors 230 and 232. The heater 206 can be implemented using a heating resistor, such as formed using tungsten silicon-nitride, polysilicon, or another electrically resistive material. The heater 206 may be positioned with respect to the fluid conduit 202 such that any fluid in the fluid conduit 202 is exposed to the heater 206, and when the heater 206 is activated, the heater 206 can heat a portion of the fluid in the vicinity of the heater 206. For example, the heater 206 may be mounted to a wall or floor of the fluid conduit 202.

The heater 206 is connected to a heater control circuit 208. For example, the heater control circuit 208 can include a transistor, such as a field effect transistor (FET), that has a first node connected to a first end 206-1 of the resistive heater 206, and a second node connected to a power supply voltage (e.g., V1 or another power supply voltage). A second end 206-2 of the heater 206 can be connected to a reference voltage, such as ground. When the transistor of the heater control circuit 208 is turned on, such as by asserting an activation signal 210, the transistor causes electrical current to be conducted through the heater 206. In some examples, the activation signal 210 can be asserted for a specified time duration to provide a signal pulse during which the heater 206 is activated.

When an electrical current passes through the heater 206, the heater 206 heats up, which causes local heating of a portion of the fluid in the vicinity of the heater 206.

In some examples, the resistances of the resistive sensors 230 and 232 are matched as closely as possible, such as to within manufacturing tolerances of the resistors used to form the resistive sensors 230 and 232. More generally, the resistances R1 and R2 of the resistive sensors 230 and 232, respectively, are considered to be “matched” if they are within a specified threshold difference of one another, such as within 0.05%, 0.1%, 0.5%, 1%, 2%, and so forth. In other words, as long as a difference between the resistances R1 and R2 is less than a specified threshold amount, the resistances R1 and R2 are considered to be matched.

Sense circuitry is used to monitor a sense connection point 212 between the resistive sensors 230 and 232. An electrical conductor (e.g., an electrically conductive trace) connects the resistive sensors 230 and 232. The sense connection point 212 is a point on this electrical conductor.

In some examples, the sense circuitry can include an analog comparator 214 (such as a differential amplifier). The comparator 214 has a first input connected to the sense connection point 212, and a second input connected to a threshold voltage Vth. In some examples, the first input is the negative input of the comparator 214, and the second input is the positive input of the comparator 214. In other examples, the first input is the positive input, and the second input is the negative input.

The comparator 214 compares a voltage Vsense at the sense connection point 212 to the threshold voltage Vth, and produces a comparator output signal 216 based on a difference between Vsense and the threshold voltage Vth. The comparator output signal 216 provides an output indication of fluid flow or no fluid based on a difference of the sense voltage and the threshold voltage.

If there is no fluid flow in the fluid conduit 202, the resistances R1 and R2 of the respective resistive sensors 230 and 232 remain substantially the same, i.e., the resistances R1 and R2 remain matched as discussed above. Each resistive sensor 230 and 232 is associated with a thermal coefficient of resistance (TCR). For certain resistive materials, the TCR is positive, while for other resistive materials, the TCR is negative. A positive TCR indicates that a resistance of the resistive material increases with increasing temperature (decreases with decreasing temperature). A negative TCR indicates that a resistance of the resistive material decreases with increasing temperature (or increases with decreasing temperature).

In the ensuing discussion, it is assumed that the TCR of the resistive sensors 230 and 232 are positive. In other examples, the resistive sensors 230 and 232 can employ resistive materials with negative TCR.

If the heater 206 is activated such that the heater 206 heats up a certain quantity of fluid (referred to as a “heated fluid slug”) in the vicinity of the heater 206, a fluid flow in the direction of the arrow 222 would carry the heated fluid slug from the location of the heater 206 to the location of the resistive sensor 230.

The heated fluid slug would increase the temperature of the resistive sensor 230, which would increase the resistance R1 of the resistive sensor 230 (assuming a positive TCR) relative to the resistance R2 of the resistive sensor 232. Because of the increased resistance R1, a greater voltage drop would occur across the resistive sensor 230, which will cause the sense voltage Vsense at the sense connection point 212 to drop relative to the condition where R1 and R2 are matched.

If R1 and R2 are matched, then Vsense at the sense connection point 212 is represented as Vsense=Vth=(V1−Vref)/2. Note that Vth is set using a threshold voltage generator 250 (discussed further below).

However, if R1>R2 due to the increased temperature of the resistive sensor 230 resulting from a flow of a heated fluid slug to the location of the resistive sensor 230, then Vsense<(V1−Vref)/2.

In some examples, if Vsense is less than Vth, then the comparator 214 sets the comparator output signal 216 at a high voltage (because the voltage at the positive input of the comparator 214 is greater than the voltage at the negative input of the comparator 214), and if Vsense is greater than or equal to Vth, the comparator 214 sets the comparator output signal 216 at a low voltage (because the voltage at the positive input of the comparator 214 is not greater than the voltage at the negative input of the comparator 214).

The comparator output signal 216 is received by a latch 218, which can store a voltage state of the comparator output signal 216. A “latch” refers to any circuit that is able to store a state of a signal for some time duration or until reset or rewritten.

The latch 218 outputs a flow indication bit 220, which can have different values depending upon whether a fluid flow is detected in the fluid conduit 202. For example, the flow indication bit 220 can have a 0 value if there is no fluid flow in the fluid conduit 202, and can have a 1 value if there is a fluid flow in a direction indicated by an arrow 222 in the fluid conduit 202. As used here, “no fluid flow” can refer to a condition where there is zero fluid flow, or where a fluid flows at a rate less than a specified non-zero flow rate threshold, i.e., the fluid flows at such a slow rate that Vsense does not shift sufficiently to cause the comparator 214 to change the voltage state of the comparator output signal 216.

Note that the sense circuitry including the comparator 214 and latch 218 depicted in FIG. 2 is able to detect the fluid flow in just one direction, the direction indicated by the arrow 222. If a fluid flow occurs in the opposite direction (opposite to the direction of the arrow 222), the flow indication bit 220 would also have a 0 value.

To detect flow in the opposite direction (opposite to the direction of the arrow 222), the sense connection point 212 can be connected to the positive input of the comparator 214 and the threshold voltage Vth can be connected to the negative input of the comparator 214. In such examples, if the positive input of the comparator 214 is connected to Vsense and the negative input of the comparator 214 is connected to Vth, then the comparator 214 can output a low voltage if Vsense is less than or equal to Vth, and can output a high voltage if Vsense is greater than Vth. In such an example, the flow indication bit 220 when set to 0 indicates presence of a fluid flow in the direction of the arrow 222, and the flow indication bit 220 when set to 0 indicates no fluid flow or a fluid flow in a direction opposite to the direction of the arrow 222.

As further shown in FIG. 2, the threshold voltage Vth is generated by the threshold voltage generator 250. In some examples, the threshold voltage generator 250 is a simple arrangement of two resistors 252 and 254 connected in series between V1 and Vref. The resistances of the resistors 252 and 254 are set at R3 and R4, respectively. In some examples, R3 and R4 are matched to the same resistance. The series connected resistors 252 and 254 form a voltage divider circuit. In some examples, the resistors 252 and 254 have a matched resistance that is to match the resistances R1 and R2 of the resistive sensors 230 and 232. In other examples, the resistors 252 and 254 have a matched resistance, but this matched resistance does not have to be matched with the resistances R1 and R2 of the resistive sensors 230 and 232.

In further examples, the ratio R1:R2 can be matched to the ratio R3:R4. In this case, the resistances of R3 and R4 can be different from the resistances R1 and R2, and in fact, R3 can be different from R4, and R1 can be different from R2. If the R1:R2 ratio matches the R3:R4 ratio, then the differential fluid flow meter 200 is able to produce an indication of fluid flow. Note that the ratio R1:R2 can be 1:1, and the ratio R3:R4 can be 1:1 in some examples. More generally, the ratio R1:R2=the ratio R3:R4.

The threshold voltage generator 250 is located in a location of the fluidic device 100 that is not affected by a fluid flow through the fluid conduit 202 or any other fluid conduit. Moreover, the series-connected resistors 252 and 254 are located in a region of the fluidic device 100 with a substantially similar temperature as a region where the resistive sensors 230 and 232 in the fluid conduit 202 are located. In other examples, the series-connected resistors 252 and 254 do not have to be located in a region of the fluidic device 100 with a substantially similar temperature as a region where the resistive sensors 230 and 232 in the fluid conduit 202 are located. For example, the series-connected resistors 252 and 254 of the threshold voltage generator 250 can be placed in close proximity to the resistive sensors 230 and 232, but outside of the fluid conduit 202, so that the temperatures of the resistive sensors 230, 232 and the resistors 252, 254 are substantially the same (to within some temperature difference threshold amount) assuming no fluid flow in the fluid conduit 202. For example, temperatures are substantially the same if the temperatures are within 0.05%, 0.1%, 0.5%, 1%, 2%, etc., of one another.

If there is no fluid flow in the fluid conduit 202, no temperature differential is present between the resistive sensors 230 and 232, which would mean that the sense voltage Vsense at the sense connection point 212 would be substantially equal to the threshold voltage Vth.

When there is a fluid flow in the fluid conduit 202, a temperature differential would be created between the resistive sensors 230 and 232, such that the sense voltage Vsense at the sense connection point 212 would be different from the threshold voltage Vth.

The combination of the simple generation of the threshold voltage Vth by the threshold voltage generator 250 and the differential sensing capability provided by the series connection of the resistive sensors 230 and 232 and the monitoring of the sense connection point 212 at an electrical conductor that connects the resistive sensors 230 and 232 allows the differential fluid flow meter 200 to be able to detect fluid flow without relying on absolute sensor measurements (e.g., absolute values of voltages output by a sensor). Techniques that rely on absolute sensor measurement levels may be sensitive to noise or variations, such as variations in characteristics of sensors, variations in power supply and reference voltage levels, variations in environmental conditions such as temperature, and so forth. The accuracy of a differential fluid flow meter according to some examples is based on matching resistances of the resistive sensors connected in series, which can be accomplished using any of various techniques, or more generally, matching a ratio of the resistances of the resistive sensors to a ratio of the resistances of the threshold voltage generator 250 discussed above.

In some examples, a controller 260 is able to control fluid flow sensing operations. As used here, a “controller” can refer to a hardware processing circuit, which can include any or some combination of a microprocessor, a core of a multi-core microprocessor, a microcontroller, a programmable integrated circuit, a programmable gate array, or another hardware processing circuit. Alternatively, a “controller” can refer to a combination of a hardware processing circuit and machine-readable instructions (software and/or firmware) executable on the hardware processing circuit.

The controller 260 may be a system controller, such as a system controller in a fluidic system (e.g., a printing system or a non-printing system) that controls fluidic operations. In other examples, the controller 260 can be part of the fluidic device 100.

The controller 260 can control assertion and de-assertion of the activation signal 210. The controller 260 can also receive the flow indication bit 220, and can determine based on the value of the flow indication bit 220 whether or not fluid flow is present in the fluid conduit 202.

In some examples, the controller 260 can also monitor a delay time duration between a time T0 when the activation signal 210 was asserted (such as an assertion of the activation signal 210 from a low state to a high state) and a time T1 when the flow indication bit 220 changed state (from indicating no fluid flow to indicating a fluid flow). This delay time duration (delay between T0 and T1) provides an indication of a flow rate of the fluid flow in the conduit 202. A smaller delay time duration between T0 and T1 provides an indication of a faster flow rate than a larger delay time duration between T0 and T1. Calibration can be performed to map different delay time durations to different flow rates, and such mapping information can be stored in a memory for use by the controller 260 in estimating a flow rate based on a detected delay time duration.

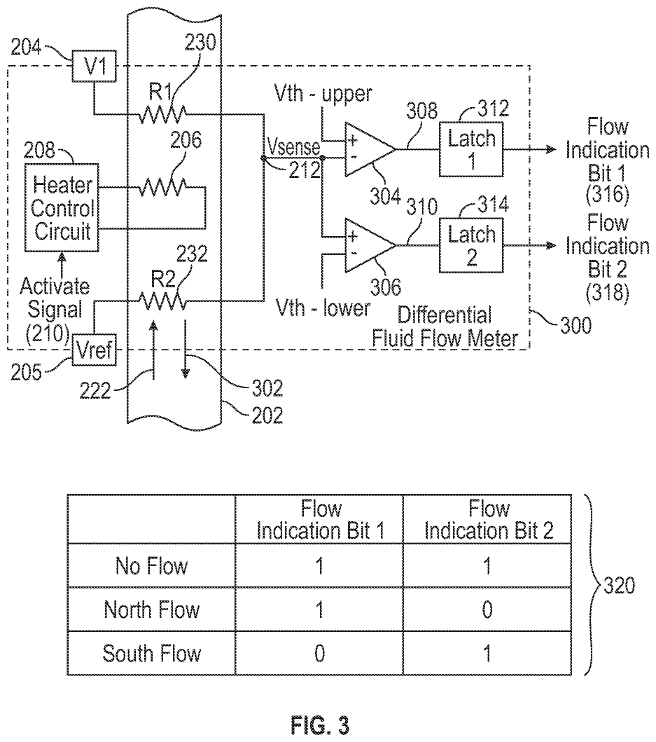

FIG. 3 shows an example in which a sense circuit is able to detect fluid flow in the fluid conduit in different directions, including the direction indicated by the arrow 222 as well as the opposite direction indicated by an arrow 302.

Components in FIG. 3 that are similar to corresponding components in FIG. 2 are assigned the same reference numerals.

The sense circuit in FIG. 3 includes two comparators 304 and 306. In some examples, the positive input of the comparator 304 is connected to an upper threshold voltage Vth-upper, and the negative input of the comparator 304 is connected to the sense voltage Vsense at the sense connection point 212. The positive input of the comparator 306 is connected to the sense voltage Vsense, and the negative input of the comparator 306 is connected to a lower threshold voltage Vth-lower, which is lower than the upper threshold voltage Vth-upper. The upper and lower threshold voltages can be generated using respective threshold voltage generators similar to the threshold voltage generator 250 shown in the FIG. 2. The different threshold voltages Vth-upper and Vth-lower can be set by varying the resistances of the resistors connected in series in each respective threshold voltage generator.

Similar to the arrangement of FIG. 2, the activation signal 210 is asserted (such as by the controller 260 of FIG. 2) for a time duration to produce a signal pulse, which activates the heater 206 to heat a heated fluid slug that carries heat from the heater 206 to the resistive sensor 230 or 232 depending on the direction of fluid flow.

Based on a difference between the sense voltage Vsense and the upper threshold voltage Vth-upper, the comparator 304 outputs a first comparator output signal 308. A latch 312 stores a voltage state of the first comparator output signal 308. The latch 312 outputs a first flow indication bit 316. The comparator 304 sets the first comparator output signal 308 high if Vsense is lower than Vth-upper (due to a fluid flow in the direction of the arrow 222). The comparator 304 sets the first comparator output signal 308 low if Vsense is greater than or equal to Vth-upper (due to no fluid flow or a fluid flow in the direction of the arrow 302).

The comparator 306 outputs a second comparator output signal 310 based on a difference between the sense voltage Vsense and the lower threshold Vth-lower. A latch 314 stores a state of the second comparator output signal 310. The latch 314 outputs a second flow indication bit 318. The comparator 306 sets the second comparator output signal 310 high if Vsense is greater than Vth-lower (due to a fluid flow in the direction of the arrow 302). The comparator 306 sets the second comparator output signal 310 low if Vsense is less than or equal to Vth-upper (due to no fluid flow or a fluid flow in the direction of the arrow 222).

A table 320 shown in FIG. 3 maps different fluid flow conditions in the fluid conduit 202 to corresponding combinations of values of the first flow indication bit 316 and the second flow indication bit 318. For example, if both the first and second flow indication bits 316 and 318 are set to the value 1, then there is no fluid flow in the fluid conduit 202. If the flow indication bit 316 has a value 1 and the flow indication bit 318 has a value 0, then a north fluid flow is indicated, which is fluid flow in the direction indicated by the arrow 222. If the flow indication bit 316 is set to 0 and the flow indication bit 318 is set to 1, then a south fluid flow is indicated, which is fluid flow in the direction indicated by the arrow 302.

An example is provided below for purposes of illustration, assuming a positive TCR for the resistive sensors 230 and 232. Assume V1=4 volts (V) and Vref=0 V, in which case Vsense is approximately 2 V in the no flow state. Also, assume Vth-upper=3 V, and Vth-lower=1 V. If there is no flow in the fluid conduit 202 and Vsense=2 V, then the comparator 304 sets the first comparator output signal 308 high and the flow indication bit 316 is set to 1 (because Vth-upper>Vsense), and the comparator 306 sets the second comparator output signal 310 high and the flow indication bit 318 is set to 1 (because Vsense>Vth-lower).

If a north fluid flow (in the direction of the arrow 222) is present, then R1 gets bigger than R2, Vsense goes lower (e.g., 0.8 V), the flow indication bit 316 is set to 1 (because Vth-upper>Vsense), and the flow indication bit 318 is set to 0 (because Vsense<Vth-lower).

If a south fluid flow (in the direction of the arrow 302) is present, then R2 gets bigger than R1, Vsense goes higher (e.g., 3.2 V), the flow indication bit 316 is set to 0 (because Vth-upper<Vsense), and the flow indication bit 318 is set to 1 (because Vsense>Vth-lower).

The table 320 can be stored as mapping information, such as by the controller 260. The controller 260 can receive the values of the fluid indication bits 316 and 318 from the differential fluid flow meter 300, and can access the mapping information (in a memory) to determine a state of fluid flow in the fluid conduit 202 (whether fluid flow is present and a direction of fluid flow). Further, the controller 260 can estimate a flow rate based on a delay time duration between when the activation signal 210 is activated and when a change in the flow indication bits 316 and 318 occurred.

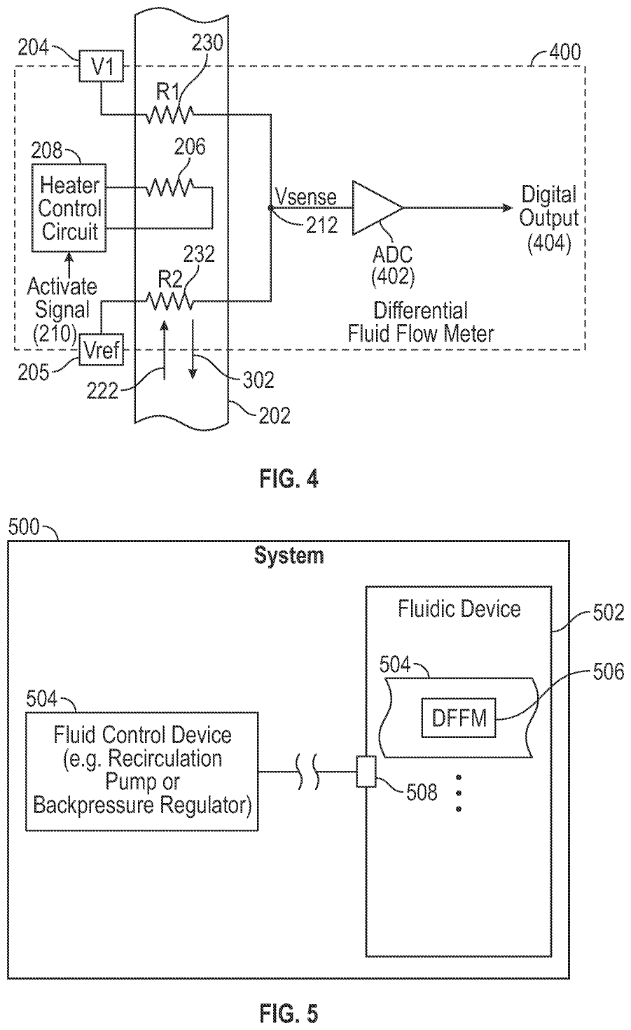

FIG. 4 is a block diagram of a differential fluid flow meter 400 according to further examples. Components in FIG. 4 that are similar to corresponding components in FIG. 2 are assigned the same reference numerals.

In the example of FIG. 4, a sense circuit includes an analog-to-digital converter (ADC) 402. The input of the ADC is connected to the sense voltage Vsense at the sense connection point 212, while a digital output 404 of the ADC 402 includes a digital value (e.g., a multi-bit value). Based on the voltage level of Vsense, the ADC 402 produces a corresponding digital value in the digital output 404. The ADC 402 produces different digital values in the digital output 404 in response to different voltage levels of Vsense. Assuming an example where the digital output 404 is 8 bits in length, the digital values of the digital output 404 can range between 0 and 255. In other examples, the digital output 404 can have a different number of bits.

A midpoint value of 127 in the digital output 404 can correspond to a state where there is no fluid flow in the fluid conduit 202. More generally, a collection of midpoint values (where a “collection” can include a single midpoint value or a range of multiple midpoint values) can correspond to a state where there is no fluid flow in the fluid conduit 202. In a further example, the collection of midpoint values can include values in a range {125, 139}, or a range {123, 141}, or a range {122, 142}, or a range {119, 135}, or another range. If the digital output 404 produced by the ADC 402 has a digital value in the collection of midpoint values, then that is an indication of no fluid flow in the fluid conduit 202.

If the digital output 404 has a digital value less than the collection of midpoint values, then that indicates a fluid flow in the direction indicated by the arrow 222. On the other, if the digital output 404 has a value that exceeds the collection of midpoint values, then that indicates a fluid flow in the direction indicated by the arrow 302.

Further, with the differential fluid flow meter 400, the controller 260 (FIG. 2) can estimate a flow rate based on a delay time duration between when the activation signal 210 is activated and when a change in the value of the digital output 404 occurred. Alternatively, with the differential fluid flow meter 400, a flow rate of the fluid flow in the conduit 202 can be estimated based on the digital value of the digital output 404, which is dependent upon a magnitude of the shift of Vsense due to a rise in temperature of the resistive sensor 230 or 232 due to a flow of the heated fluid slug that is heated by the heater 206. A larger deviation of the digital value from the collection of midpoint values indicates a higher fluid flow rate.

In some examples, the differential fluid flow meter 108 shown in FIG. 1 can be used to evaluate a health of a corresponding nozzle 102 (or group of nozzles 102). The differential fluid flow meter 108 can measure a fluid flow when the corresponding nozzle 102 is not firing (i.e., is not ejecting a fluid) to provide a first measurement (e.g., in the form of a first digital value in the digital output 404 of FIG. 4). The first measurement taken by the differential fluid flow meter 108 in this condition is stored in a memory, such as by the controller 260 (FIG. 2).

The controller 260 then activates (fires) the nozzle 102, which causes a fluid flow in the fluid conduit 104. The differential fluid flow meter 108 measures the fluid flow in the fluid conduit 104 during the firing of the nozzle 102 to provide a second measurement (e.g., in the form of a second digital value in the digital output 404 of FIG. 4). This second measurement is compared by the controller 260 to the first measurement to determine whether a difference between the first measurement and the second measurement is within an expected range (e.g., exceeds a specified threshold difference). If not, that indicates that the nozzle 102 may not be firing properly. If the difference is within the expected range, then that indicates that the nozzle 102 is healthy.

The differential fluid flow meter 200, 300, or 400 according to some examples are relatively simple and occupy a relatively small amount of an overall fluidic device, such as a fluidic die.

FIG. 5 is a block diagram of an example system 500 that includes a fluidic device 502 and a fluid control device 504 that is able to control an aspect of fluid in the fluidic device 502. The fluidic device 502 includes a fluid conduit 504 and a differential fluid flow meter 506 according to some examples. Note that the fluidic device 502 may include multiple fluid conduits 504 and respective differential fluid flow meters 506. Although depicted as a single fluidic device 502, there may be multiple fluidic devices in the system 500. For example, a fluid module (such as a printhead module) can include multiple fluidic dies, each with its set of differential fluid flow meters according to some examples of the present disclosure.

In some examples, the fluid control device 504 is fluidically coupled to fluid port(s) 508 of the fluidic device 502. In an example, the fluid control device 504 includes a recirculation pump that is able to pump a fluid into an inlet fluid port of the fluidic device 502. The fluid that is pumped into the fluidic device 502 flows through fluid conduit(s) 504 of the fluidic device 502, and exits an outlet fluid port of the fluidic device 502. The outlet fluid port is coupled to the recirculation pump. In this manner, the recirculation pump can cause recirculation of a fluid through the fluidic device 502. More generally, the fluid control device 504 includes a fluid pump to cause a fluid flow in the fluidic device 502.

In some examples, the differential fluid flow meter 506 (or multiple differential fluid flow meters 506) can be used to check that the recirculation of fluid in the fluidic device 502 is occurring in an expected manner. Recirculation may deviate from a target operation if the recirculation pump is not operating properly, or if there are clog(s) in fluid conduit(s) 504 in the fluidic device 502.

The differential fluid flow meter 506 makes a first measurement (e.g., in the form of a first digital value in the digital output 404 of FIG. 4) of a fluid flow when the recirculation pump is off. Next, the recirculation pump is activated, at which time the differential fluid flow meter 506 makes a second measurement (e.g., in the form of a second digital value in the digital output 404 of FIG. 4).

The first and second measurements can be received by the controller 260 (FIG. 2). The controller 260 determines based on a difference between the first and second measurements whether the recirculation flow is proceeding as expected. If the difference is not within an expected range (e.g., less than a specified threshold difference), then the controller 260 can indicate that the recirculation is not operating as expected.

In other examples, the fluid control device 504 includes a backpressure regulator that maintains a backpressure in the fluidic device 502. The backpressure is maintained to ensure that pressure inside the fluidic device 502 is less than an environmental pressure outside the fluidic device 502. For example, when the fluidic device 502 is not activated, the backpressure will prevent fluid from dripping out of nozzles.

To test whether the backpressure maintained by the backpressure regulator is as expected, the differential fluid flow meter 506 can be used to measure fluid flow while nozzles are fired. The backpressure regulator can be swept across a range of different backpressures, and measurements can be made at the different backpressures while fluidic actuators are activated. The different measurements across the range of backpressures are used by the controller 260 to determine whether the backpressure regulator is operating properly, and also to determine a target backpressure setting (the amount of backpressure to be applied to the fluidic device 502), such as for calibrating the backpressure regulator.

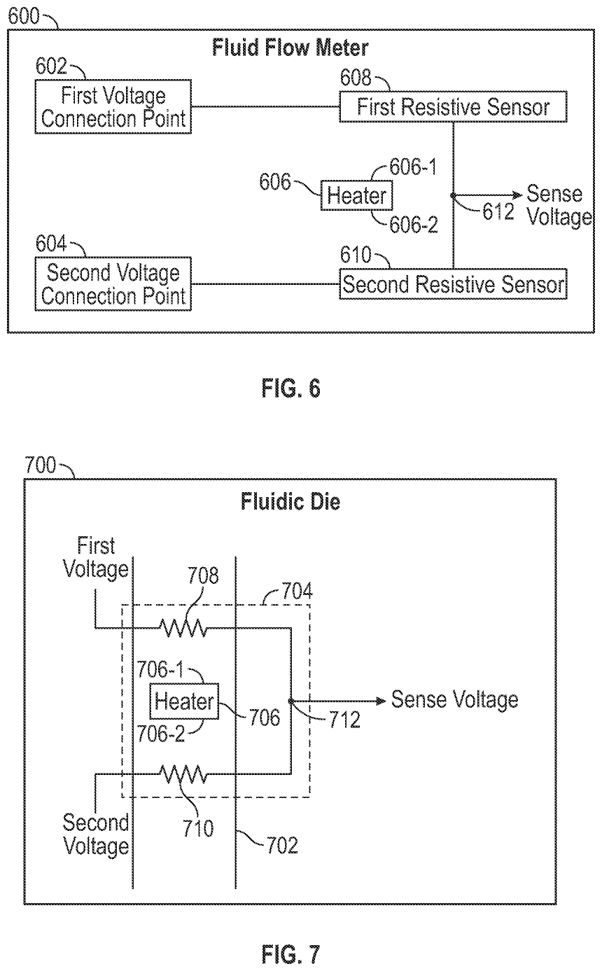

FIG. 6 is a block diagram of a fluid flow meter 600 for a conduit to carry a fluid. The fluid flow meter 600 includes a first voltage connection point 602 (e.g., 204 in FIG. 2, 3, or 4), a second voltage connection point 604 (e.g., 205 in FIG. 2, 3, or 4), and a heater 606 (e.g., 206 in FIG. 2, 3, or 4). The fluid flow meter 600 further includes a plurality of resistive sensors including a first resistive sensor 608 on a first side 606-1 of the heater 606 and a second resistive sensor 610 on an opposite second side 606-2 of the heater 606. The first resistive sensor 608 and the second resistive sensor 610 are connected in series between the first voltage connection point 602 and the second voltage connection point 604, wherein a sense connection point 612 between the first resistive sensor and the second resistive sensor is to output a sense voltage that provides an indication of a fluid flow in the conduit.

In some examples, the heater 606 when activated produces heat to be carried by the fluid in the conduit to one of the first resistive sensor 608 and the second resistive sensor 610 depending on a direction of the fluid flow in the conduit.

In some examples, the fluid flow meter 600 includes a voltage comparator (e.g., 214 in FIG. 2 or 304 or 306 in FIG. 3) including a first input electrically connected to the sense connection point 612 between the first resistive sensor 608 and the second resistive sensor 610, and a second input to receive a threshold voltage.

In some examples, the fluid flow meter 600 includes an ADC converter (e.g., 402 in FIG. 4) including an input connected to the sense connection point 612 between the first resistive sensor 608 and the second resistive sensor 610, the ADC converter to produce a digital value based on the sense voltage at the sense connection point between the first resistive sensor 608 and the second resistive sensor 610.

FIG. 7 is a block diagram of a fluidic die 700 including a fluid conduit 702 to carry a fluid, and a flow meter 704 fluidically coupled to the fluid conduit 702. The flow meter 704 includes a heater 706 and a plurality of resistive sensors including a first resistive sensor 708 on a first side 706-1 of the heater 706 and a second resistive sensor 710 on a second side 706-2 of the heater 706. The first resistive sensor 708 and the second resistive sensor 710 are connected in series between a first voltage (e.g., a power supply voltage) and a second voltage (e.g., a reference voltage such as ground) of the fluidic die 700, where a sense connection point 712 between the first resistive sensor 708 and the second resistive sensor 710 is to output a sense voltage that provides an indication of a fluid flow in the fluid conduit.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

1. A fluid flow meter for a conduit to carry a fluid, comprising:
a first voltage connection point;
a second voltage connection point;
a heater; and
a plurality of resistive sensors comprising a first resistive sensor on a first side of the heater and a second resistive sensor on a second side of the heater, wherein the first resistive sensor and the second resistive sensor are connected in series between the first voltage connection point and the second voltage connection point, wherein a sense connection point between the first resistive sensor and the second resistive sensor is to output a sense voltage that provides an indication of a fluid flow in the conduit.

2. The fluid flow meter of claim 1, wherein the heater when activated produces heat to be carried by the fluid in the conduit to one of the first resistive sensor and the second resistive sensor depending on a direction of the fluid flow in the conduit.

3. The fluid flow meter of claim 1, wherein the first voltage connection point is to connect to a power supply voltage, and the second voltage connection point is to connect to a reference voltage.

4. The fluid flow meter of claim 1, further comprising a voltage comparator comprising a first input electrically connected to the sense connection point between the first resistive sensor and the second resistive sensor, and a second input to receive a threshold voltage.

5. The fluid flow meter of claim 4, wherein the voltage comparator is to output an output indication of the fluid flow based on a difference of the sense voltage and the threshold voltage.

6. The fluid flow meter of claim 4, wherein the voltage comparator is a first voltage comparator, and the threshold voltage is a first threshold voltage, the fluid flow meter further comprising:
a second voltage comparator comprising a first input to receive a second threshold voltage, and a second input electrically connected to the sense connection point between the first resistive sensor and the second resistive sensor.

7. The fluid flow meter of claim 6, wherein the first threshold voltage is different from the second threshold voltage.

8. The fluid flow meter of claim 4, wherein the threshold voltage is from a voltage divider circuit comprising a first resistor and a second resistor having a matched resistance.

9. The fluid flow meter of claim 1, further comprising an analog-to-digital (ADC) converter comprising an input connected to the sense connection point between the first resistive sensor and the second resistive sensor, the ADC converter to produce a digital value based on the sense voltage at the sense connection point between the first resistive sensor and the second resistive sensor.

10. A fluidic die comprising:
a fluid conduit to carry a fluid; and
a flow meter fluidically coupled to the fluid conduit, the flow meter comprising:
a heater, and
a plurality of resistive sensors comprising a first resistive sensor on a first side of the heater and a second resistive sensor on a second side of the heater, wherein the first resistive sensor and the second resistive sensor are connected in series between a first voltage and a second voltage of the fluidic die, wherein a sense connection point between the first resistive sensor and the second resistive sensor is to output a sense voltage that provides an indication of a fluid flow in the fluid conduit.

11. The fluidic die of claim 10, further comprising a nozzle to eject a fluid droplet, wherein the flow meter is to provide an indication of the fluid flow in the conduit responsive to ejection of the fluid droplet through the nozzle.

12. The fluidic die of claim 10, further comprising:
a voltage comparator comprising a first input electrically connected to the sense connection point between the first resistive sensor and the second resistive sensor, and a second input to receive a threshold voltage, wherein the voltage comparator is to output an output indication of the fluid flow based on a difference of the sense voltage and the threshold voltage; and
a threshold voltage generator comprising a voltage divider circuit to produce the threshold voltage, the voltage divider circuit comprising a first resistor and a second resistor, wherein a first ratio of a resistance of the first resistor to a resistance of the second resistor matches a second ratio of a resistance of the first resistive sensor to a resistance of the second resistive sensor.

13. A system comprising:
a fluid control device; and
a fluidic device having a fluid port fluidically coupled to the fluid control device, the fluidic device comprising a fluid conduit to carry a fluid, and a flow meter fluidically coupled to the fluid conduit, wherein the flow meter is to output a flow indication of a fluid flow in the fluid conduit that is subject to an operation of the fluid control device, wherein the fluidic device further comprises a flow meter fluidically coupled to the fluid conduit, the flow meter comprising:
a heater, and
a plurality of resistive sensors comprising a first resistive sensor on a first side of the heater and a second resistive sensor on a second side of the heater, wherein the first resistive sensor and the second resistive sensor are connected in series between a first voltage and a second voltage of the fluidic device, wherein a sense connection point between the first resistive sensor and the second resistive sensor is to output a sense voltage that provides the flow indication.

14. The system of claim 13, wherein the fluid control device comprises a fluid pump, and the system further comprises a controller to test the fluid pump using measurements from the flow meter.

15. The system of claim 13, wherein the fluid control device comprises a backpressure regulator, and the system further comprises a controller to test the backpressure regulator using measurements from the flow meter.
